(19) United States
(12) Patent Application Publication
(10) Pub. No.: US 2020/0342358 A1
(43) Pub. Date: Oct. 29, 2020

(54) CLIENT, SERVER, AND CLIENT-SERVER SYSTEM ADAPTED FOR GENERATING PERSONALIZED RECOMMENDATIONS

(71) Applicant: HUAWEI TECHNOLOGIES CO., LTD., Shenzhen (CN)

(72) Inventors: Adrian FLANAGAN, Helsinki (FI); Kuan Eeik TAN, Helsinki (FI); Qiang FU, Helsinki (FI); Yevgeniy IVANCHENKO, Helsinki (FI)

(21) Appl. No.: 16/956,258

(22) PCT Filed: Dec. 22, 2017
(86) PCT No.: PCT/EP2017/084491

§ 371 Date: Jun. 19, 2020

(51) Int. Cl. G06N 20/00; G06N 5/04; H04L 29/08; H04L 29/06

(52) U.S. Cl. CPC G06N 20/00; H04L 67/42; H04L 67/34; G06N 5/04

(57) ABSTRACT

A client including a processor and a memory having computer readable instructions stored thereon that, when executed by the processor, cause the client to connect to a server utilizing a global set of items and at least one model. The client is also caused to utilize at least one model downloaded from said server. The client is additionally caused to generate a recommendation set, including at least one of said items based on said at least one of said downloaded models and a local client data set stored on said client. The recommendation set includes a personalized item recommendation for a user of said client.

### TECHNICAL FIELD

The disclosure relates to an improved client, server, and client-server system allowing generation of personalized recommendations.

### BACKGROUND

A client-server system is a structure in which the tasks of the system are divided between the provider of a service, i.e. a server, and service requesters, i.e. clients. The server may run one or more programs which share their resources with the clients. The client, on the other hand, does not share any of its resources, but requests a server's content or service function. The clients, i.e. user devices such as mobile phones or tablets, are an important part of a machine learning process used in such a client-server system, since each client is a source of data, the data being used for building the models used in the machine learning process and for generating the results from the models.

The results may, e.g., be a recommendation of one or several specific items, taken from a larger set of items, which specific items are predicted, by one or several models, to be of interest to the user of the client. An item is, e.g., a video available for viewing, an application available for downloading, or a physical object such as a piece of clothing available for purchase. The clients and the items may be collected in a so-called client-item matrix.

The machine learning process comprises creating complex models and algorithms which may be used for prediction-making, e.g. by exploiting patterns found in historical and transactional data. There are several techniques for prediction-making, but one common feature is the application of a predictive score, such as a rating, to individual elements within a larger set of elements, such as e.g. video clips or pieces of clothing. The predictions indicate the probability of the user viewing the video, downloading the application, or purchasing the piece of clothing, and may subsequently be used for generating recommendations to the user.

It is difficult to achieve an efficient machine learning process, since it is hard to find patterns and oftentimes there is not sufficient training data available; as a result, machine learning processes often fail to deliver. Hence, it is important that as much data as possible is available to the machine learning process. For a client-server system, this translates to the server having access to as many clients, and their data, as possible. Each client is a user device such as a mobile phone or a tablet, and it is not only a source of data used for building models used in the machine learning process, but it is also the medium for delivering the results of the models, e.g. recommending the video clips or pieces of clothing, which have received the highest scores, to the user of the client.

The prior art approach to such model building comprises sending user data to a central server, where different algorithms are used to process the data, build the models, and generate results in the form of recommendations. The recommendations are to be individual and personal, wherefore the more personal the data, the better the recommendations.

Clients, such as mobile phones and tablets, comprise different kinds of personal user data, e.g., client location, which may be considered very sensitive personal data, and downloaded applications, which may be considered not particularly sensitive personal data. Regardless of the sensitivity levels, the data is still considered to be personal user data.

Regulations such as, e.g., the GDPR (General Data Protection Regulation) which is to be enforced in the EU countries in 2018, as well as general scrutiny of how companies collect, store, and use user data are issues which make generating personalized recommendations more difficult, and maybe even impossible when explicit user opt-in consent is required to collect the user's data and to store and process it. With surveys disclosing opt-in rates as low as 20%, trying to generate such personalized recommendations may no longer be useful.

Furthermore, collecting gigabytes of user data daily, for a large number of clients, as well as storing and using the data securely, requires expensive infrastructure and administration solutions.

Providing results such as personalized recommendations to the user of a client is an important means of engaging users in a service, e.g., by helping users find video clips they would enjoy watching while filtering out content that they are not interested in, e.g. due to having already watched a video clip.

### SUMMARY

It is an object to provide an improved client, server, and client-server system.

The foregoing and other objects are achieved by the features of the independent claims. Further implementation forms are apparent from the dependent claims, the description, and the figures.

According to a first aspect, there is provided a client adapted for generating personalized item recommendations for a user of the client, the client being connected to a server utilizing a global set of items and at least one model, the client being configured to utilize at least one model downloaded from the server, and generate a recommendation set, comprising at least one of the items, by means of at least one of the downloaded model(s) and a local client data set stored on the client.

A client, comprising these features, allows efficient and secure generation of personalized item recommendations since some of the calculations, necessary for generating personalized item recommendations, are executed on the client, and some of the data used in the calculations is stored on the client.

In a possible implementation form of the first aspect, the model(s) comprise Collaborative Filtering, Predictive Modeling, and/or Deep Learning Models, models which are well-established for different types of use.

In a further possible implementation form of the first aspect, the client data set comprises implicit user feedback and/or explicit user feedback, allowing estimates, used for generating personalized item recommendations, to be calculated on the basis of user actions, as well as allowing user reviews to be taken into account in the calculations.

In a further possible implementation form of the first aspect, the recommendation set is generated by means of a combination of two models and the client data set, wherein one model is Collaborative Filtering and the other model is Predictive Modeling, models which, when combined, allow a highly efficient generation of personalized item recommendations.

In a further possible implementation form of the first aspect, the recommendation set comprises a first recommendation set generated by means of one model and the client data set, and a second recommendation set generated by means of a further model, the first recommendation set, and the client data set, allowing the first recommendation set to be improved.

In a further possible implementation form of the first aspect, generating the second recommendation set comprises selecting and scoring individual items of the first recommendation set, allowing generation of a smaller, and/or more correct, recommendation set.

In a further possible implementation form of the first aspect, the client is configured to update each downloaded model by means of: calculating an updated model by means of the downloaded model and the local client data set, uploading the updated model to the server, wherein the updated model is used for the server calculating a new updated model, downloading the new updated model from the server, and calculating at least one further updated model by means of the new updated model and the local client data set.

A client, comprising these features, allows for a machine learning process which is efficient, since it has access to the client data of all clients connected to a server, as well as secure, since the client data related to an individual client remains on the very same. Since the server, connected to the client, does not have to collect or store large amounts of client data, the process is time- and cost-effective as well.

In a further possible implementation form of the first aspect, the client is configured to calculate at least one update for each model by means of: calculating an update for each downloaded model by means of the local client data set, uploading the update to the server, wherein the update is used for the sever calculating an updated model, downloading the updated model from the server, calculating a new update for the updated model by means of the local client data set, calculating at least one further updated model by means of the updated model, the new update and the local client data set.

As mentioned above, a client, comprising these features, allows for a machine learning process which is efficient as well as secure. Since the client does not have to download or upload entire models from the server, the process is particularly effective.

In a further possible implementation form of the first aspect, calculating an update comprises calculating a value for each item by means of a function f(i,j), allowing a value which is disengaged from any personal client data to be calculated.

In a further possible implementation form of the first aspect, the client is further configured to generate a recommendation set by means of the further updated model and the local client data set, allowing as much client data as possible to be used.

According to a second aspect, there is provided a server adapted for assisting in generating personalized item recommendations for a user of a client, on the client, the server being configured to utilize a global set of items and at least one model, the server being connected to a plurality of clients, each client being configured to download the model(s), and generate updated model(s) or updates for the model(s), the server further being configured to: generate new updated model(s) by means of updated models or updates uploaded by at least one of the clients, and transmit the new updated model(s) to the plurality of clients, wherein the new updated model(s) and a local client data set, stored on the client, are utilized for each client (i) generating the personalized item recommendations.

A server, comprising these features, allows efficient and secure generation of personalized item recommendations since some of the calculations, necessary for generating personalized item recommendations, are executed on the client, and some of the data used in the calculations is stored on the client.

In a possible implementation form of the second aspect, the server is assigned the at least one model prior to utilizing the model(s), the act of assigning comprising one of selecting a random model or a previously known model, allowing use of either a new model or a previously used model as the starting point for the calculations.

In a further possible implementation form of the second aspect, the server is configured to generate the new updated model(s) by means of: determining several of the clients, each determined client being configured to calculate updated model(s) by means of the downloaded model(s) and the local client data set, and to upload the updated model(s) to the server, receiving updated model(s) uploaded by at least one of the determined clients, calculating the new updated model by means of averaging the received, updated model(s).

A server, comprising these features, allows for a machine learning process which is efficient, since it has access to the client data of all clients connected to a server, as well as secure, since the client data related to an individual client remains on the very same. Since the server, connected to the client, does not have to collect or store large amounts of client data, the process is time- and cost-effective as well.

In a further possible implementation form of the second aspect, the server is configured to generate the new updated model(s) by means of: determining several of the clients, each determined client being configured to calculate an update for each model by means of the local client data set, and to upload the update(s) to the server, receiving the update(s) uploaded by at least one of the determined clients, calculating the new updated model by means of the model and an aggregate of the received updates.

As mentioned above, a server, comprising these features, allows for a machine learning process which is efficient as well as secure. Since the client does not have to download or upload entire models from the server, the process is particularly effective.

According to a third aspect, there is provided a machine learning client-server system adapted for generating personalized item recommendations for a user of a client, the client-server system comprising a plurality of clients, described above, and a server, described above. A client-server system, comprising these features, allows efficient and secure generation of personalized item recommendations since some of the calculations, necessary for generating personalized item recommendations, are executed on the client, and some of the data used in the calculations is stored on the client.

These and other aspects will be apparent from the embodiments described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1 is a schematic drawing of a client-server system according to one embodiment of the present disclosure.

FIG. 2 is a schematic drawing of a client-server system according to a further embodiment of the present disclosure.

### DETAILED DESCRIPTION

As mentioned in the background section, a client-server system is a structure in which the tasks of the system are divided between the provider of a service, i.e. a server, and service requesters, i.e. clients such as mobile phones or tablets. The service to be provided may be a video service, all of the user data associated with the video service being stored on the server.

Prior art model building comprises sending personal user data from a client to a central server where the data is processed, models are built, and results are generated and sent back to the client. The results may, e.g., be an estimate to be used for generating recommendations of one or several specific items, taken from a larger set of items, which specific items are predicted, by one or several models, to be of interest to the user of the client. An item is, e.g., a video available for viewing, an application available for downloading, or a physical object such as a piece of clothing available for purchase.

The number of clients as well as available items is usually very large, and are preferably collected in a client-item matrix R=(rᵢⱼ)∈R^{N×m}, N being the maximum number of clients i connected to the server, and M being the maximum number of items j available on the server.

Given the number of clients N can be several million, and the number of items M several thousand, the client-item matrix R may be sparse with many elements rᵢⱼ unspecified. One object of the present disclosure is to replace such unspecified elements with their estimates [symbol] .

Contrary to prior art, and due to technological advancement such as a general increase in computational ability of clients, the present disclosure generates such estimates while still maintaining all personal user data on the client, i.e. personal user data is neither used nor stored on a central server. Hence, the amount of data to be transferred to, and stored on, the server is reduced, and issues related to data collection and user privacy are avoided. The elements rᵢⱼ as well as the estimates [symbol] are used for generating personalized item recommendations.

The above is achieved, in part, by means of Collaborative Filtering. In short, in Collaborative Filtering a model is built from a user's past behavior, such as items previously purchased or selected and/or numerical ratings given to those items by the user, as well as similar decisions made by other users. This model is then used to predict which other items the user may have an interest in. Collaborative Filtering is one of the most used models to generate recommendations for a user, either independently or in combination with other types of models such as, e.g., Predictive Modeling. Predictive Modeling is, preferably, used to apply a predictive score, such as a rating, to the above-mentioned estimates [symbol] .

In prior art, these models both require gathering all data to be used in building the model to be collected in a centralized server.

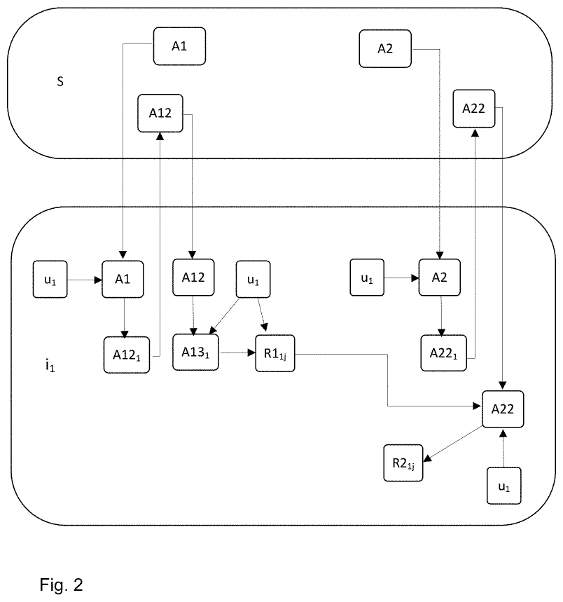

As previously mentioned, the number of clients as well as the number of items is usually very large, wherefore a combination of models may be used to provide only relevant, personalized item recommendations to the user of a specific client i. As an example, shown also in FIG. 2, a Collaborative Filtering model A1 may be used to generate a first set of item recommendations R1ᵢⱼ, a so-called candidate set comprising some, if not all, of the above-mentioned elements rᵢⱼ and estimates [symbol] , whereafter a Predictive Modeling model A2 may be used to create the final, usable recommendations R2ᵢⱼ by scoring the initially recommended items R1ᵢⱼ and sorting them by weight.

The estimates [symbol] may be based on implicit and/or explicit feedback from not only the specific client but a plurality of clients, in one embodiment all possible clients. Implicit feedback comprises actions taken by the user, e.g. downloading an application. Explicit feedback comprises user reviews of items. Collaborative Filtering only uses these two kinds of data, while the above-mentioned Predictive Modeling may use additional kinds of explicit feedback such as demographics, behavioral data, other user activity related data such as where and when an item was interacted with and what kind of device was used, and also personal user data such as name and login data.

The basis of all Collaborative Filtering recommender systems is the above-mentioned client-item matrix R=(rᵢⱼ)∈R^{N×M}. For the sake of simplicity, the description below will at times equate a client i with its user, and an item j with an application available for downloading.

In Collaborative Filtering, the value rᵢⱼ is derived from explicit feedback such as user reviews, e.g. rᵢⱼ∈(1, . . . , 5).

In the case of implicit feedback such as, e.g., the user downloading an application, rᵢⱼ=1 when user/client i downloaded application/item j, where 1≤i≤N and 1≤j≤M, while rᵢⱼ is unspecified otherwise.

Collaborative Filtering is used to replace the unspecified rᵢⱼ with their estimates [symbol] , e.g. by means of Matrix Factorization.

Matrix Factorization involves creating a client factor vector xᵢ∈R^{k×1},

$${x}_{i} = ( \begin{matrix}{x}_{i 1} \\ {x}_{i 2} \\ ⋮ \\ {x}_{ik}\end{matrix} ) ,$$

for each client i, and an item factor vector yⱼ∈R^{k×1},

$${y}_{j} = ( \begin{matrix}{y}_{j 1} \\ {y}_{j 2} \\ ⋮ \\ {y}_{jk}\end{matrix} ) ,$$

for each item j. k is the number of factors, which is typically much lower than both M and N. The estimate for an unspecified rᵢⱼ is then given by [symbol] =xᵢ^{T}yⱼ.

The first model A1 is a factor matrix A1=X(i,k) comprising a plurality of client factor vectors (xᵢ), and the second model A2 is a factor matrix A2=Y (j,k) comprising a plurality of item factor vectors (yⱼ).

The client factor vectors are collected into a matrix X∈R^{k×M} where X=(x₁, x₂, . . . , xᵢ, . . . , x_{M}), and the item factor vectors are collected into a matrix Y∈R^{k×N} where Y=(y₁, y₂, . . . , yⱼ, . . . , y_{N}). The client-item matrix R is, in other words, also defined as R=X^{T}Y.

For the case of explicit feedback, a set of binary variables pᵢⱼ are introduced to indicate whether the user/client i has rated an application/item j or not, where

$${p}_{ij} \{ \begin{matrix}1 & {r}_{ij} > 0 \\ 0 & {r}_{ij} = 0\end{matrix} .$$

A value pᵢⱼ>0 means that the application/item j has been rated, while a value pᵢⱼ=0 means that the user has not rated the application/item j or is simply not aware an application/item j exists.

For the case of implicit feedback, a set of binary variables pᵢⱼ are introduced to indicate the preference of user/client i for application/item j, where

$${p}_{ij} \{ \begin{matrix}1 & {r}_{ij} > 0 \\ 0 & {r}_{ij} = 0\end{matrix} .$$

A value pᵢⱼ=0 can have many interpretations including the user/client i not being interested in an application/item j or not being aware an application/item j exists. To account for this, a confidence parameter cᵢⱼ is introduced, defined as cᵢⱼ=1+∝rᵢⱼ where α>0. The implicit feedback problem is, in other words, different from the standard explicit feedback problem in that the confidence levels cᵢⱼ need to be taken into account.

Any updates are to be made across all clients i and all items j rather than just the clients i for which there are downloads j.

In prior art Collaborative Filtering models, xᵢ is updated by means of the equation xᵢ=(YCⁱY^{T}+λI)⁻¹YCⁱp(i), where Y, Y∈R^{k×N}, is the above-mentioned matrix of item factor vectors, Cⁱ is a diagonal matrix with Cⱼⱼⁱ=cᵢⱼ, I is an identity matrix, and p(i)∈R^{N×1} is a binary preference variable vector for the client i.

Similarly, yⱼ is updated by means of the equation yⱼ=(XC^{j}YX^{T}+λI)⁻¹XC^{j}p(j) where X, X∈R^{k×M}, is the above-mentioned matrix of client factor vectors, C^{j} is a diagonal matrix with Cᵢᵢ^{j}=cᵢⱼ, and p(i)∈R^{N×1} is a binary preference variable vector for the client i.

In summary, the above described prior art method uses Y for calculating X, and X for calculating Y, repeating and alternating between the two equations at least until a suitable convergence criteria is met. The convergence criteria is a predefined limit value, for example as 1%. C and p, which are based on user/client data, are used for calculating both X and Y, wherefore all user data has to be located in the same place as X and Y, i.e. on the server. This is referred to as the ALS (Alternating Least Squares) method for Collaborative Filtering, and it is frequently used in prior art.

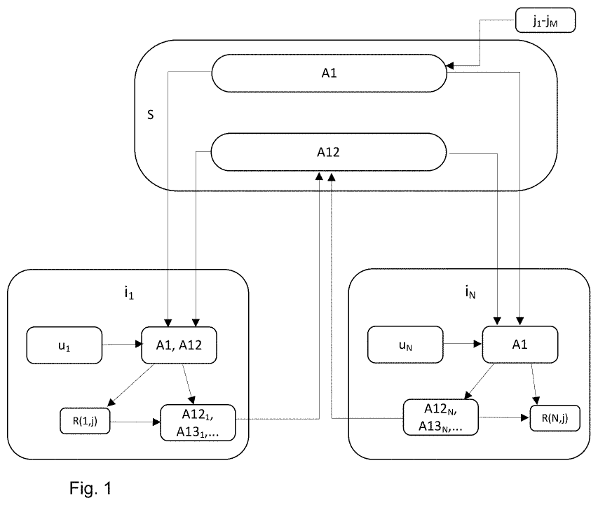

The embodiments of the present disclosure, shown schematically in FIG. 1, comprises an adaptation of the ALS method such that a different approach is taken to calculating Y, which adaptation allows the calculations to be distributed to the client, hence avoiding the need to transfer client data back to the server. All item factor vectors yⱼ∈R^{k×1} are located on the server, updated on the server, and thereafter distributed to each client i. All client factor vectors xᵢ∈R^{k×1} remain on the client i, are updated on the client using local client data uᵢ, and the item factor vectors from the server. The updates are calculated from item j on each client i and transmitted to the server where they are aggregated and the yⱼ are updated.

All of the values necessary for calculating xᵢ=(YCⁱY^{T}+λI)⁻¹YCⁱp(i) are available on the client i, as long as a current set of item factor vectors yⱼ∈R^{k×1} have been downloaded onto the client i, Y being the matrix of item factor vectors, Cⁱ a diagonal matrix with Cⱼⱼⁱ=cᵢⱼ, λ the regularization factor, I an identity matrix, and p(i)∈R^{N×1} is a binary preference variable vector for the client i. Furthermore, all of these values are independent from the corresponding values of any other client i. Hence, what corresponds to a first step of the ALS algorithm can be calculated on each individual client i without reference to any other client.

However, when using the ALS method, the calculation of yⱼ, yⱼ=VC^{j}YX^{T}+λI)⁻¹XC^{j}p(j), requires the matrix of client factor vectors X, wherefore this update must take place on the server where all client data is available. Rather than directly calculating an update of yⱼ, as in the ALS method, the present disclosure applies a gradient descent approach to calculate the updated yⱼ on the server. More specifically, the present disclosure calculates the updated yⱼ, i.e. the updated matrix Y, by means of equation

$${y}_{j} = {y}_{j} - γ \frac{\partial J}{\partial {y}_{j}} ,$$

γ being a gain function and ∂J/∂yⱼ; being calculated by means of equation

$$\frac{\partial J}{\partial {y}_{j}} = - 2 {Σ}_{i} [ {c}_{ij} ( {p}_{ij} - {x}_{i}^{T} {y}_{j} ) ] {x}_{i} + 2 λ {y}_{j} .$$

The above-mentioned equation

$$\frac{\partial J}{\partial {y}_{j}}$$

originates from the cost function J, J=ΣᵢΣⱼcᵢⱼ(pᵢⱼ−xᵢ^{T}yⱼ)²+λ(Σᵢ∥xᵢ∥²+(Σ^{j}∥Y^{j}∥²), where λ is the regularization factor. The cost function J is minimized by alternating the calculations of the client factor vector matrix X and the item factor vector matrix Y. The first step of minimizing the cost function J is to differentiate J with regards to xᵢ for all clients i and yⱼ for all items j, by means of ∂J/∂xᵢ and ∂J/∂yⱼ.

The initial starting value of xᵢ is calculated directly by means of

$$\frac{\partial J}{\partial {x}_{i}} = 0 ,$$

xᵢ=(YCⁱY^{T}+λI)⁻¹YCⁱp(i) as in the ALS method, which is possible since, as mentioned above, the values necessary are available on the client i.

∂J/∂yⱼ, on the other hand, comprises a component which is a summation over all clients i, said summation being defined as f(i,j). f(i,j) is calculated on the client, based only on client data, by means of ƒ(i,j)=[cᵢⱼ(pᵢⱼ−xᵢ^{T}yⱼ)]xᵢ, i.e. f(i,j) is calculated on each client i, independently of all other clients.

Each client i reports back, to the server, an evaluation of the value f(i,j) calculated for each item j, whereafter all of the client evaluations are summarized, on the server, by means of

$$\frac{\partial J}{\partial {y}_{j}} = - 2 {Σ}_{i} f ( i , j ) + 2 λ {y}_{j}$$

and thereafter applied to

$${y}_{j} = {y}_{j} - γ \frac{\partial J}{\partial {y}_{j}} .$$

The present disclosure relates, in other words, to training at least one model, e.g. a Collaborative Filtering model A1, without having to transfer user data from the client to the server, and at the same time using the model A1 to calculate estimates [symbol] for the unspecified elements of the client-item matrix R, the estimates to be used for generating personalized recommendations. As shown in FIG. 1, the machine learning model A1 is initially located on a centralized server, and distributed to each user device/client i. The initial model A1 is updated, on each client i, using model A1 and client data uᵢ located on the client. Updates dA1ᵢ, or complete updated models A12ᵢ, generated on each user device/client, are transferred back to the server where they are aggregated across all determined clients to generate a new model component A12, which in turn is downloaded to the clients i and updated to form model A13ᵢ.

By model is meant either an entire model, or a part of a model. In the latter case, the model comprises at least two parts A1, A2. One individual part A1ᵢ is assigned to the client, and one part A2 is downloaded to the client i from the server. The individual part A1ᵢ is updated by means of the downloaded server part and an element of local client data uᵢ, resulting in an updated individual part A12ᵢ. An individual value for each item j is calculated on the client using the downloaded server part A2, the updated individual part A12ᵢ, and the element of local client data uᵢ. An evaluation of the value is uploaded to the server, from each client, such that the server part can be updated by means of an aggregate of such evaluations, forming updated server part A22. The updated server part A22 is downloaded to the clients, and yet a further updated individual part A13ᵢ is calculated on the client, by means of the downloaded updated server part A22 and an element of local client data uᵢ. Thereafter, at least one unspecified element of the client-item matrix R can be updated, by replacing the unspecified element with its estimate, by means of the further updated individual part A13ᵢ and the updated server part A22.

The model A13ᵢ, stored locally on the client i, and the client data uᵢ are used for calculating estimates replacing unspecified elements of the client-item matrix R. Hence the client data uᵢ never leaves the client i. The updated client-item matrix R is, in other words, used to generate a first recommendation set R1ᵢⱼ.

A further model, such as Predictive Modeling, is used to select, rescore, sort, and subsequently narrow down, the first recommendation set R1ᵢⱼ to a second recommendation set R2ᵢⱼ.

One aspect of the present disclosure relates to a client adapted for generating personalized item recommendations for a user of the client i. The client is connected to a server utilizing a global set of items j₁, . . . , j_{M} and at least one model A1, . . . , AK. The client i is configured to utilize at least one model A1, . . . , AK downloaded from the server, and to generate a recommendation set Rᵢⱼ comprising at least one jₚ of the items j₁, . . . , j_{M}, by means of at least one of the downloaded model(s) A1, . . . , AK and a local client data set uᵢ stored on the client i, as shown in FIG. 1.

The model(s) A1, . . . , AK comprise Collaborative Filtering, Predictive Modeling, and/or Deep Learning Models. The client data set uᵢ comprises implicit user feedback and/or explicit user feedback.

The recommendation set Rᵢⱼ is generated by means of a combination of two models A1, A2 and the client data set uᵢ, wherein one model A1 is Collaborative Filtering and the other model A2 is Predictive Modeling.

The recommendation set Rᵢⱼ comprises a first recommendation set R1ᵢⱼ generated by means of one model A1, A12, A13 and the client data set uᵢ, and a second recommendation set R2ᵢⱼ generated by means of a further model A2, A22, the first recommendation set R1ᵢⱼ, and the client data set uᵢ. This is shown schematically in FIG. 2.

Generating the second recommendation set R2ᵢⱼ comprises selecting and scoring individual items jₚ of the first recommendation set R1ᵢⱼ.

The client i may be configured to update each downloaded model by means of the following steps, shown schematically in FIGS. 1 and 2:
A. calculate an updated model A12ᵢ, . . . , AK2ᵢ by means of the downloaded model A1, . . . , AK and the local client data set uᵢ,
B. upload the updated model A12ᵢ, . . . , AK2ᵢ to the server, wherein the updated model A12ᵢ, . . . , AK2ᵢ is used for the server calculating a new updated model A12, . . . , AK2,
C. download the new updated model A12, . . . , AK2 from the server,
D. calculate at least one further updated model A13ᵢ, . . . , AK3ᵢ by means of the new updated model A12, . . . , AK2 and the local client data set uᵢ.

The model A may be updated, on the client, as mentioned in steps A and D above. The updating is executed, when the model is a Collaborative Filtering model, by means of equation xᵢ=(Yp(i)Y^{T}+λI)⁻¹YRⁱp(i), wherein p(i) is a binary preference variable vector for the client i, Rⁱ is a vector of known inputs for client i, I is an identity matrix, and λ is a regularization parameter.

The model A may be updated, on the server, as mentioned in step B above. The updating is executed by averaging the updated models which were uploaded to the server, also in step B.

The client (i) may further be configured to calculate at least one update for each model by means of the following steps:
A. calculate an update dA1ᵢ, . . . , dAKᵢ for each downloaded model A1, . . . , AK by means of the local client data set uᵢ,
B. upload the update dA1ᵢ, . . . , dAKᵢ to the server, wherein the update dA1ᵢ, . . . , dAKᵢ is used for the sever calculating an updated model A12, . . . , AK2,
C. download the updated model A12, . . . , AK2 from the server,
D. calculate a new update dA12ᵢ, . . . , dAK2ᵢ for the updated model A12, . . . , AK2 by means of the local client data set uᵢ,
E. calculate at least one further updated model A13ᵢ, . . . , AK3ᵢ by means of the updated model A12, . . . , AK2, the new update dA12ᵢ, . . . , dAK2ᵢ and the local client data set uᵢ.

Calculating an update dA1ᵢ₁, . . . , dAKᵢ, dA12ᵢ₁, . . . , dAK2ᵢ comprises calculating a value for each item j₁, . . . , j_{M} by means of a function f(i,j).

The model A may be updated, on the client, as mentioned in steps A, D, and E above. The updating, when the model is a Collaborative Filtering model, is executed by means of equation xᵢ=(Yp(i)Y^{T}+λI)⁻¹YRⁱp(i), wherein p(i) is a binary preference variable vector for the client i, Rⁱ is a vector of known inputs for client i, I is an identity matrix, and A is a regularization parameter.

The model A may be updated, on the server, as mentioned in step B above. The updating is executed by means of equation

$${y}_{j} = {y}_{j} - γ \frac{\partial J}{\partial {y}_{j}} ,$$

wherein γ is a gain function. Each model A, e.g A1, has a cost function J1 which is to be minimized with respect to the model parameter

$$y . \frac{\partial J}{\partial {y}_{j}}$$

is given by the sum of dA1ᵢ, i.e. the dA1 provided by clients i₁-i_{N}.

The client i is further configured to generate a recommendation set Rᵢⱼ by means of the further updated model A13ᵢ, . . . , AK3ᵢ and the local client data set uᵢ.

A further aspect of the present disclosure relates to a server adapted for assisting in generating personalized item recommendations for a user of a client i, on the client i, the server being configured to utilize a global set of items j₁, . . . , j_{M} and at least one model A1, . . . , AK. The server is connected to a plurality of clients each client i being configured to download the model(s) A1, . . . , AK, and generate updated model(s) A12ᵢ, . . . , AK2ᵢ or updates dA1ᵢ, . . . , dAKᵢ for the model(s) A1, . . . , AK. The server is further configured to: generate new updated model(s) A12, . . . , AK2 by means of updated models A12ᵢ, . . . , AK2ᵢ or updates dA1ᵢ, . . . , dAKᵢ uploaded by at least one of the clients i₁, . . . , i_{N}, and transmit the new updated model(s) A12, . . . , AK2 to the plurality of clients i₁, . . . , i_{N}. The new updated model(s) A12, . . . , AK2 and a local client data set uᵢ, stored on the client i, are utilized for each client i generating the personalized item recommendations. This is shown schematically in FIGS. 1 and 2

The server is assigned the at least one model A1, . . . , AK prior to utilizing the model(s), the act of assigning comprising one of selecting a random model or a previously known model.

The server may be configured to generate the new updated model(s) by means of the following steps:
A. determine several of the clients i₁, . . . , i_{N}, each determined client i being configured to calculate updated model(s) A12ᵢ, . . . , AK2ᵢ by means of the downloaded model(s) A1, . . . , AK and the local client data set uᵢ, and to upload the updated model(s) A12ᵢ, . . . , AK2ᵢ to the server,
B. receive updated model(s) A12ᵢ, . . . , AK2ᵢ uploaded by at least one of the determined clients i₁, . . . , i_{N},
C. calculate the new updated model A12, . . . , AK2 by means of averaging the received, updated model(s) A12ᵢ, . . . , AK2ᵢ.

The server may furthermore be configured to generate the new updated model(s) by means of the following steps:
A. determine several of the clients i₁, . . . , i_{N}, each determined client i being configured to calculate an update dA1ᵢ, . . . , dAKᵢ for each model A1, . . . , AK by means of the local client data set uᵢ, and to upload the update(s) dA1ᵢ, . . . , dAKᵢ to the server,
B. receive the update(s) dA1ᵢ, . . . , dAKᵢ uploaded by at least one of the determined clients i₁, . . . , i_{N},
C. calculate the new updated model A12, . . . , AK2 by means of the model A1, . . . , AK and an aggregate of the received updates dA1ᵢ, . . . , dAKᵢ.

The model A may be updated, on the server, as mentioned in step C above. The updating is executed by means of equation

$${y}_{j} = {y}_{j} - γ \frac{\partial J}{\partial {y}_{j}} ,$$

wherein γ is a gain function.

Yet another aspect of the present disclosure relates to a machine learning client-server system adapted for generating personalized item recommendations directed towards the user of a client i. The system comprises the above-mentioned server and a plurality of the above-mentioned clients.

FIG. 1 shows the flow of information in a client-server system adapted for updating a client-item matrix R schematically. Value f(i,j), for item j, is calculated on the client i using local user data uᵢ. The values f(i,j) for a plurality of items j, comprised in updated model A12ᵢ, are transmitted back to the server S, from a plurality of clients, and aggregated, whereafter initial model A1 is updated to model A12. Hence, no local client data uᵢ need be transferred out of the client i to update model A1. The same procedure is thereafter executed for at least model A12, resulting in a model A13ᵢ on each client i, which model is used for generating personalized item recommendations directed towards the user of a client i.

The system comprises one server S and a N number of clients i. For the sake of simplicity, FIG. 1 shows only two clients, i₁ and i_{N}, i.e. i_{N} equals i₂. Client i₁ utilizes local client data uᵢ, i.e. uᵢ, as well as downloaded model A1. Similarly, client i₂ utilizes local client data u₂, as well as model A1.

FIG. 2 similarly shows the flow of information in a client-server system comprising one server S, one client i₁, and which utilizes two models A1, A2 for generating personalized item recommendations.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope.

What is claimed is:

1. A client, comprising:
a processor; and
a memory having computer readable instructions stored thereon that, when executed by the processor, cause the client to:
connect to a server utilizing a global set of items and at least one model;
utilize at least one model downloaded from said server; and
generate a recommendation set, comprising at least one of said items based on said at least one of said downloaded models and a local client data set stored on said client,
wherein the recommendation set comprises a personalized item recommendation for a user of said client.

2. The client according to claim 1, wherein said at least one model comprises at least one of a Collaborative Filtering mode, a Predictive Modeling mode, or a Deep Learning Model.

3. The client according to claim 1, wherein said client data set comprises at least one of implicit user feedback or explicit user feedback.

4. The client according to claim 1, wherein said recommendation set is generated based on a combination of two models and said client data set, wherein a first model is a Collaborative Filtering model and a second model is a Predictive Modeling model.

5. The client according to claim 1, wherein said recommendation set comprises a first recommendation set generated based on a first model and said client data, and a second recommendation set generated based on a second model, said first recommendation set, and said client data set.

6. The client according to claim 5, wherein the client is further caused to:
select and score individual items of said first recommendation set to generate said second recommendation set.

7. The client according to claim 1, wherein said client is configured to update each downloaded model, and the client is further caused to:
calculate an updated model based on said downloaded model and said local client data set;
upload said updated model to said server to calculate a new updated model;
download said new updated model from said server; and
calculate at least one further updated model based on said new updated model and said local client data set.

8. The client according to claim 1, wherein said client is configured to calculate at least one update for each model, and the client is further caused to:
calculate an update for each downloaded model based on said local client data set;
upload said update to said sever to calculate an updated model;
download said updated model from said server;
calculate a new update for said updated model based on said local client data set; and
calculate at least one further updated model based on said updated model, said new update and said local client data set.

9. The client according to claim 8, wherein calculating an update comprises calculating a value for each item based on a cost function.

10. The client according to claim 7, wherein said client is further caused to:
generate a recommendation set based on said further updated model and said local client data set.

11. A server, comprising:
a processor; and
a memory having computer readable instructions stored thereon that, when executed by the processor, cause the server to:
connect to a plurality of clients to communicate one or more models to each client and cause each client to generate one or more updated models or updates for said one or more models;
generate one or more new updated models based on the updated models or the updates received from at least one of said clients; and
transmit said new updated models to said plurality of clients to cause each client to generate personalized item recommendations for a user of said client based on said new updated model(s) and a local client data set, stored on said client,
wherein said personalized item recommendations comprise at least one item of a global set of items utilized by the server.

12. The server according to claim 11, wherein said server is assigned at least one model of the one or more models prior to utilizing said at least one model, and the at least one model is assigned based on a random model or a previously known model.

13. The server according to claim 11, wherein said server is further caused to:
determine several of said clients, each determined client being configured to calculate the updated models based on said models received from the server and said local client data set, and to upload said updated models to said server;
receive the updated models unloaded by at least one of said determined clients; and
calculate said new updated models by averaging said received, updated models.

14. The server according to claim 11, wherein said server is further caused to:
determine several of said clients, each determined client (i) being configured to calculate the update for each model based on said local client data set, and to upload said updates to said server;
receive said updates uploaded by at least one of said determined clients; and
calculate said new updated model based on said model and an aggregate of said received updates.

15. (canceled)

16. A machine learning client-server system, comprising:
a server utilizing a global set of items and at least one model; and
a plurality of clients, each client comprising:
a processor; and
a memory having computer readable instructions stored thereon that, when executed by the processor, cause the client to:
connect to said server;
utilize at least one model downloaded from said server; and
generate a recommendation set, comprising at least one of said items based on said at least one of said downloaded models and a local client data set stored on said client,
wherein the recommendation set comprises a personalized item recommendation for a user of said client.

17. The machine learning client-server system according to claim 16, wherein said server is configured to:
communicate the one or more models to each client and cause each client to generate one or more updated models or updates for said one or more models;
generate one or more new updated models based on the updated models or the updates received from at least one of said clients; and
transmit said new updated models to said plurality of clients to cause each client to generate the personalized item recommendations for the user of said client based on said new updated models and a local client data set stored on said client.

18. The machine learning client-server system according to claim 16, wherein said server is assigned at least one model of the one or more models prior to utilizing said at least one model, and the at least one model is assigned based on a random model or a previously known model.

19. The machine learning client-server system according to claim 16, wherein said client is configured to update each downloaded model, and the client is further caused to:
calculate an updated model based on said downloaded and said local client data set;
upload said updated model to said server to calculate a new updated model;
download said new updated model from said server; and
calculate at least one further updated model based on said new updated model-and said local client data set.

20. The machine learning client-server system according to claim 16, wherein said client is configured to calculate at least one update for each model, and the client is further caused to:
calculate an update for each downloaded model based on said local client data set;
upload said update to said server to calculate an updated model;
download said updated model from said server;
calculate a new update for said updated model based on said local client data set; and
calculate at least one further updated model based on said updated model said new update and said local client data set.

21. The machine learning client-server system according to claim 20, wherein said client is further caused to:
generate a recommendation set based on said further updated model and said local client data set.
